(19) United States
(12) Patent Application Publication
(10) Pub. No.: US 2017/0154694 A1
(43) Pub. Date: Jun. 1, 2017

(54) PRESSURIZER SPRAY APPARATUS WITH HALF-CIRCLE TYPE NOZZLES

(71) Applicant: KEPCO ENGINEERING & CONSTRUCTION COMPANY, INC., Gyeonggi-do (KR)

(72) Inventor: Yoon Jae CHOI, Daejeon (KR)

(21) Appl. No.: 15/287,890

(22) Filed: Oct. 7, 2016

(30) Foreign Application Priority Data
Nov. 30, 2015 (KR) 10-2015-0169279

(51) Int. Cl. G21D 1/00

(52) U.S. Cl. CPC G21D 1/00; G21Y 2002/50; G21Y 2004/40

(57) ABSTRACT

A pressurizer spray apparatus with half-circle type nozzles, which is provided in a pressurizer of a pressurized light-water reactor type nuclear power plant, includes a spray inlet pipe penetrating the pressurizer from outside to inside and having a hollow tube shape, a spray ring arranged inside the pressurizer and having a ring shape and a hollow tube shape, a connecting pipe connecting the spray ring and the spray inlet pipe and having a hollow tube shape, and a spray nozzle provided on an outer circumferential surface of the spray ring and capable of discharging a low-temperature coolant into the pressurizer.

### CROSS-REFERENCE TO RELATED APPLICATION

This application claims the benefit of Korean Patent Application No. 10-2015-0169279, filed on Nov. 30, 2015, in the Korean Intellectual Property Office, the disclosure of which is incorporated herein in its entirety by reference.

### BACKGROUND

1. Field

One or more embodiments relate to a pressurizer spray apparatus provided at a pressurizer of a pressurized light-water reactor type nuclear power plant, and more particularly, to a pressurizer spray apparatus with half-circle type nozzles which may reduce effect due to a change in the temperature of pipes and thermal stratification and decrease piping fatigue by using a spray ring having half-circle type nozzles.

2. Description of the Related Art

Reactor coolant system of pressurized light-water reactor type nuclear power plants needs to maintain operating conditions such as a high temperature and a high pressure. A high-temperature coolant of a reactor coolant system needs to maintain a supercooling state. In order to maintain the supercooling state, a sufficient pressure is necessary and thus a pressurizer is installed reactor coolant system in a pressurized light-water reactor type nuclear power plant to provide a sufficient pressure to the coolant.

However, during the operation of a nuclear power plant, a reactor coolant system may experience various transient states. In some transient states, an excessive pressure increase is generated so that integrity of a reactor coolant pressure boundary may be endangered. To prevent such a danger, a relatively low-temperature coolant is sprayed into a steam space in the pressurizer, thereby restricting the increase in the pressure of the pressurizer. To this spray line end, a spray apparatus is provided at the pressurizer.

Referring to FIG. 1, a spray apparatus according to a related art may include a pressurizer 10, a spray nozzle 20 disposed in the pressurizer 10, a vertical pipe 30 connected to the spray nozzle 20, and a horizontal pipe 40 connected to the vertical pipe 30 and inclined by about 10° from the horizontal. A coolant 50 is sprayed through the spray nozzle 20 so that the coolant 50 having a relatively low temperature is sprayed over a steam space of the pressurizer 10. In the process, high-temperature steam loses heat and thus is condensed. As the high-temperature steam is condensed to be liquid, the pressure of the pressurizer can be lowered.

However, the spray apparatus according to the related art may have the following problems.

The spray apparatus according to the related art may include the vertical pipe 30 connected to the spray nozzle 20 and the horizontal pipe 40 connected to the vertical pipe 30 and inclined by about 10° from the horizontal. When there is no spray, the vertical pipe 30 is exposed to a saturated steam 70 having a high temperature and the horizontal pipe 40 inclined by about 10° is simultaneously exposed to both of the saturated steam 70 of a high temperature and the coolant 50 of a low temperature. In this state, a temperature boundary layer in which fluids having different temperatures coexist is formed between the saturated steam 70 of a high temperature and the coolant 50 of a low temperature in the horizontal pipe 40, thereby generating a thermal stratification 60.

Thermal stratification 60 causes a large temperature difference between upper and lower portions of the horizontal pipe 40. A large temperature difference between two fluids (the saturated steam 70 and the subcooled coolant 50) causes a load to the pipe wall due to stratification in the temperature on the horizontal pipe 40 and greatly affects integrity of the horizontal pipe 40. Furthermore, continuous occurrence of thermal stratification 60 may cause piping fatigue on the horizontal pipe 40 and greatly affect the integrity of the horizontal pipe 40. Accordingly, the occurrence of thermal stratification 60 may act as a major portion in that accumulated usage factor of the spray apparatus approaches a limit.

### SUMMARY

One or more embodiments include a pressurizer spray apparatus with half-circle type nozzles, which may reduce influence due to a change in the temperature of piping and thermal stratification and decrease piping fatigue by using a spray ring having half-circle type nozzles, thereby removing piping region in which two types of fluids having a large temperature difference coexist.

Additional aspects will be set forth in part in the description which follows and, in part, will be apparent from the description, or may be learned by practice of the presented embodiments.

According to one or more embodiments, a pressurizer spray apparatus with half-circle type nozzles, which is provided in a pressurizer of a pressurized light-water reactor type nuclear power plant, includes a spray inlet pipe penetrating the pressurizer from outside to inside and having a hollow tube shape, a spray ring arranged inside the pressurizer and having a ring shape and a hollow tube shape, a connecting pipe connecting the spray ring and the spray inlet pipe and having a hollow tube shape, and a spray nozzle provided on an outer circumferential surface of the spray ring and capable of discharging a low-temperature coolant into the pressurizer.

The spray ring may be horizontally arranged in the pressurizer.

Inside of the spray inlet pipe and the spray ring may be filled with the low-temperature coolant during a continuous spray flow is provided.

The spray nozzle may be provided in a plural number on the outer circumferential surface of the spray ring, and the spray nozzle may have a half-circular shape.

The connecting pipe may include a first bent portion connected to the spray inlet pipe in a “U” shape lying horizontally and a second bent portion connected to the first bent portion in a “U” shape lying horizontally, and one end of the second bent portion may be connected to the spray ring.

The spray inlet pipe may be provided in a plural number and connected to the spray ring via a different connecting pipe, the connecting pipe being provided in a plural number and the plurality of spray inlet pipes are communicated with one another through the spray ring.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a spray apparatus provided at a pressurizer according to a related art;

FIG. 2 is a schematic view of a pressurizer spray apparatus with half-circle type nozzles according to an embodiment;

FIG. 3 is a cross-sectional view taken along a line A-A of FIG. 2; and

FIG. 4 is a cross-sectional view taken along a line B-B of FIG. 2.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

The present disclosure relates to a pressurizer spray apparatus 100 with half-circle type nozzles, which may reduce influence due to a change in the temperature of piping and thermal stratification and decrease piping fatigue by using a spray ring having half-circle type nozzles.

The pressurizer spray apparatus 100 with half-circle type nozzles according to the present embodiment is provided at a pressurizer 110 of a pressurized light-water reactor type nuclear power plant and may include a spray inlet pipe 120, a spray ring 130, a connecting pipe 140, and a spray nozzle 150.

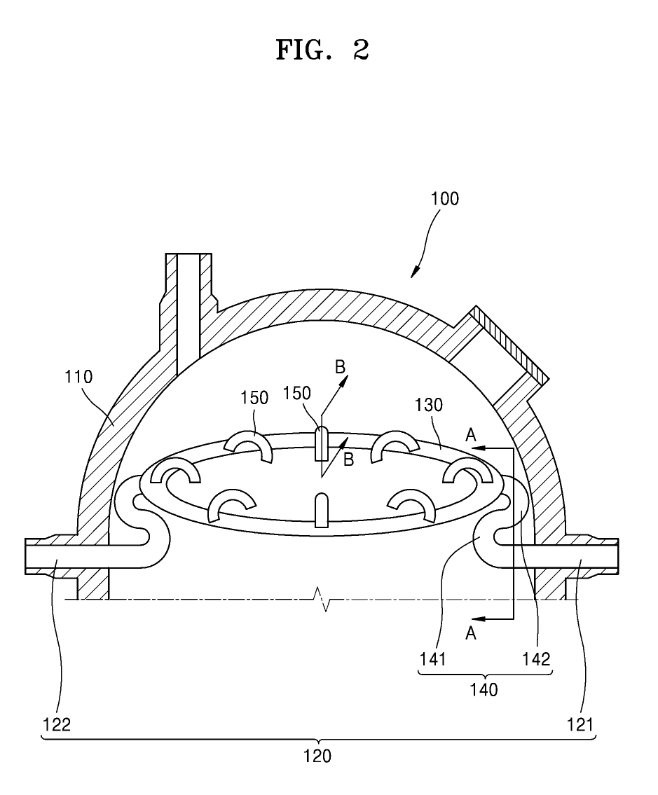

Referring to FIG. 2, the spray inlet pipe 120 having a hollow tube shape penetrates through the pressurizer 110 from the outside into the inside. The spray inlet pipe 120 supplies a low-temperature coolant to the inside of the pressurizer 110. The spray inlet pipe 120 may be provided in a plural number. In the present embodiment, the spray inlet pipe 120 may include a first spray inlet pipe 121 and a second spray inlet pipe 122. As the spray inlet pipe 120 is provided in a plural number, an efficiency of supplying the low-temperature coolant to the inside of the pressurizer 110 may be improved, and the spray sources can be multiplied and diversified.

The spray ring 130 is provided inside the pressurizer 110 and has a hollow tube shape. The spray ring 130 has a ring shape. In other words, the spray ring 130 is a pipe having a ring shape and arranged inside the pressurizer 110. The low-temperature coolant supplied from the spray inlet pipe 120 flows into the spray ring 130 via the connecting pipe 140.

The spray ring 130 may be horizontally placed inside the pressurizer 110. In other words, the spray ring 130 may be arranged parallel to the ground in a direction perpendicular to a direction in which the gravity acts. The spray ring 130 may be filled with the low-temperature coolant which is provided by the continuous spray and the normal spray when required. If the spray ring 130 is not horizontally arranged, the low-temperature coolant may be kept inclined in the spray ring 130.

The low-temperature coolant in the spray ring 130 is discharged into the pressurizer 110 via the spray nozzles 150 to be described later. If the spray ring 130 is not horizontally arranged, the low-temperature coolant is kept inclined in the spray ring 130. As a result, the low-temperature coolant may not be uniformly discharged through the spray nozzle 150. In other words, the low-temperature coolant flows in a direction in which the spray ring 130 is inclined, to be gathered in one side of the spray ring 130, so that no low-temperature coolant remains in a direction opposite to the direction in which the spray ring 130 is inclined. Accordingly, the low-temperature coolant may be irregularly discharged into the pressurizer 110.

However, the arrangement of the spray ring 130 is not limited to the horizontal arrangement and thus the spray ring 130 may be arranged in various types. For example, when there is a need to irregularly discharge the low-temperature coolant into the pressurizer 110, the spray ring 130 may be arranged inclined.

The connecting pipe 140 connects the spray ring 130 and the spray inlet pipe 120 and has a hollow tube shape. The low-temperature coolant supplied from the spray inlet pipe 120 flows into the spray ring 130 through the connecting pipe 140. In other words, the connecting pipe 140 is a hollow pipe having one end connected to the spray inlet pipe 120 and the other end connected to the spray ring 130. The connecting pipe 140 may be integrally formed with the spray inlet pipe 120 or with the spray ring 130.

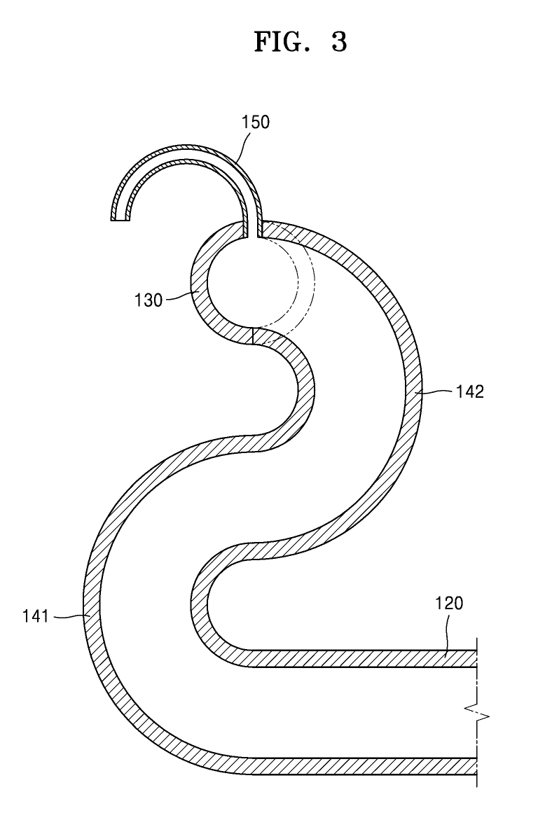

The connecting pipe 140 may have various shapes. Referring to FIG. 3, the connecting pipe 140 according to the present embodiment may include a first bent portion 141 and a second bent portion 142. The first bent portion 141 is connected to the spray inlet pipe 120 in a “U” shape lying horizontally. The second bent portion 142 is connected to and extends from the first bent portion in a “U” shape lying horizontally. In other words, one end of the first bent portion 141 having a “U” shape lying horizontally is connected to the spray inlet pipe 120, and the other end of the first bent portion 141 is connected to the second bent portion 142 having a “U” shape lying horizontally. One end of the second bent portion 142 is connected to the spray ring 130, and the other end of the second bent portion 142 is connected to the first bent portion 141. In other words, the connecting pipe 140 including the first bent portion 141 and the second bent portion 142 may have a “duck's neck” shape (“S” shape).

As the connecting pipe 140 including the first bent portion 141 and the second bent portion 142 has a “duck's neck” shape (“S” shape), the connecting pipe 140 may absorb a mechanical load due to thermal expansion of each part. The spray inlet pipe 120 and the spray ring 130 receive mechanical loads due to thermal expansion by high-temperature saturated steam inside the pressurizer 110 and the low-temperature coolant in the spray inlet pipe 120 and the spray ring 130. In other words, as temperature increases or decreases, the spray inlet pipe 120 and the spray ring 130 repeats expansion and contraction, thereby receiving mechanical loads.

When the connecting pipe 140 has a structure of directly connecting the spray inlet pipe 120 and the spray ring 130, it may be difficult to absorb the mechanical loads due to thermal expansion and contraction. Referring to FIG. 2, the thermal expansion and contraction of the spray ring 130 and the thermal expansion of the spray inlet pipe 120 are generated in the opposite directions. Accordingly, if the connecting pipe 140 directly connects the spray inlet pipe 120 and the spray ring 130, the connecting pipe 140 may directly receive mechanical loads due to thermal expansion acting in the opposite directions.

However, when the connecting pipe 140 including the first bent portion 141 and the second bent portion 142 has a “duck's neck” shape (“S” shape), the connecting pipe 140 may absorb the mechanical loads due to thermal expansion. In other words, the first bent portion 141 having a “U” shape lying horizontally may absorb thermal expansion of the spray inlet pipe 120, and the second bent portion 142 having a “U” shape lying horizontally may absorb thermal expansion of the spray ring 130. Accordingly, the first bent portion 141 and the second bent portion 142 may absorb the mechanical loads due to thermal expansion acting in the opposite directions. Thus, the mechanical loads due to thermal expansion may be reduced.

The shape of the connecting pipe 140 is not limited thereto. The connecting pipe 140 may have various shapes if the connecting pipe 140 has a structure capable of connecting the spray inlet pipe 120 and the spray ring 130 and absorbing the mechanical loads due to thermal expansion.

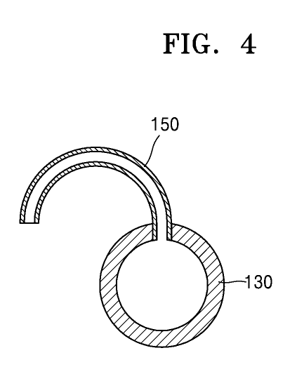

Referring to FIG. 4, the spray nozzle 150 is provided on an outer circumferential surface of the spray ring 130 and discharges the low-temperature coolant into the pressurizer 110. The spray nozzle 150 has a hollow tube shape and is connected to the inside of the spray ring 130. The low-temperature coolant supplied through the spray inlet pipe 120 flows into the spray ring 130 via the connecting pipe 140. The low-temperature coolant flowing into the spray ring 130 is discharged into the pressurizer 110 through the spray nozzle 150.

The spray nozzle 150 may have various shapes. The spray nozzle 150 may be provided in a plural number on the outer circumferential surface of the spray ring 130 having a ring shape. Although the spray nozzles 150 are arranged on the spray ring 130 at a constant interval, the spray nozzles 150 may be arranged at an irregular interval. Also, the spray nozzle 150 may be located at various positions on the outer circumferential surface of the spray ring 130 so that a spray area may be extended.

In the present embodiment, the shape of the spray nozzle 150 may be half-circular. In other words, one end of the spray nozzle 150 having a half-circular shape may be connected to the spray ring 130 and the low-temperature coolant may be discharged through the other end of the spray nozzle 150.

The shape of the spray nozzle 150 is not limited to a half-circle and may be changed in various ways. The spray nozzle 150 may have a “C” shape or an arch shape.

The inside of the spray inlet pipe 120 and the spray ring 130 may be filled with the low-temperature coolant. As the inside of the spray inlet pipe 120 and the spray ring 130 is filled with the low-temperature coolant, generation of thermal stratification in the spray inlet pipe 120 and the spray ring 130 may be prevented.

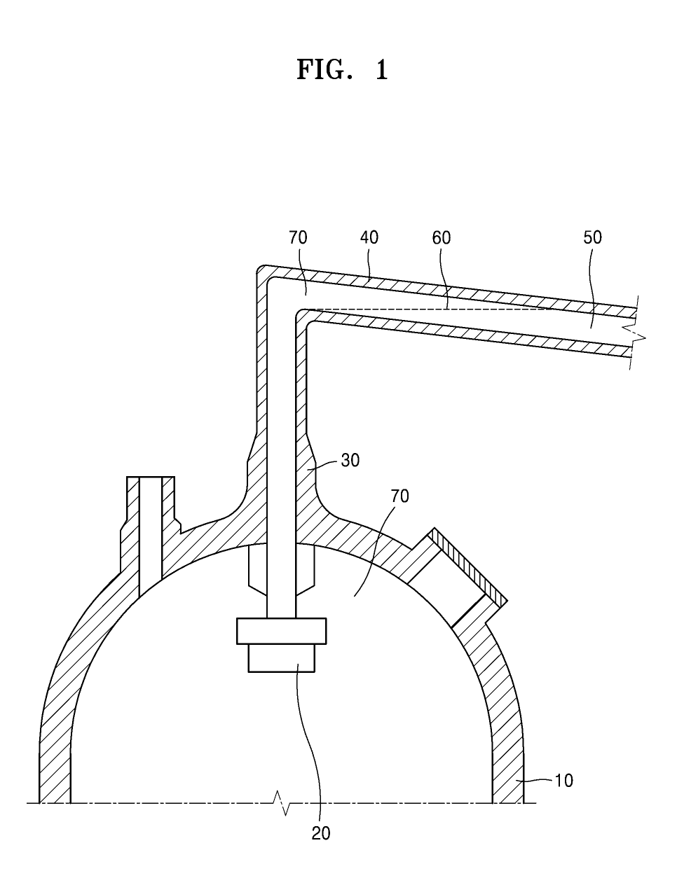

In other words, the pipe according to the related art has the thermal stratification 60 (see FIG. 1) in which the saturated steam of a high temperature and the low-temperature coolant of a low-temperature forming layers. However, as both the spray inlet pipe 120 and the spray ring 130 are filled with the low-temperature coolant, no high-temperature saturated steam exists in the inside of the spray inlet pipe 120 and the spray ring 130. Accordingly, thermal stratification is not generated in the spray inlet pipe 120 and the spray ring 130.

The spray nozzle 150 is formed in a half-circle to have the spray ring 130 always filled with the low-temperature coolant. If the spray nozzle 150 is partially inclined with respect to the ground, like the horizontal pipe 40 according to the related art, the coolant in the spray ring 130 flows into the spray nozzle 150 and thus thermal stratification is generated. Also, when the spray nozzle 150 is directed upward from the ground to prevent the coolant in the spray ring 130 from flowing into the spray nozzle 150, a depressurization efficiency of the low-temperature coolant discharged through the spray nozzle 150 is lowered and the low-temperature coolant may be directly sprayed onto the structure of the pressurizer 110 having a high temperature. As a result, the wall of pressurizer 110 is exposed to a large temperature difference so that another problem may be generated.

Accordingly, when the spray nozzle 150 has a half-circular shape, the high-temperature saturated steam may be prevented from flowing into the spray ring 130 through the spray nozzle 150 due to continuous spray flow, and the lowering of the depressurization efficiency of the low-temperature coolant discharged through the spray nozzle 150 having a half-circular shape and the direct contacting of the low-temperature coolant with the structure of the pressurizer 110 may be prevented. Accordingly, the spray ring 130 may be always filled with the low-temperature coolant and a problem generated as the coolant directly contacts the structure of the pressurizer 110 may be prevented.

The spray inlet pipe 120 may be provided in a plural number and connected to the spray ring 130 via individual connecting pipe 140. In other words, the spray inlet pipe 120 may be independently connected to the spray ring 130 as many as is necessary. When a plurality of the spray inlet pipes 120 are connected to the spray ring 130, the spray ring 130 may work as a common pipe of the spray inlet pipe 120, and the spray inlet pipes 120 are communicated with one another via the spray ring 130. The coolant supplied from the spray inlet pipes 120 fills the inside of the spray ring 130 and is discharged into the pressurizer 110 through the spray nozzle 150.

The pressurizer spray apparatus 100 with half-circle type nozzles according to the present embodiment operates as follows.

The coolant that is relatively low-temperature is supplied through the spray inlet pipe 120, flowing into the spray ring 130 via the connecting pipe 140. The low-temperature coolant flowing into the spray ring 130 is sprayed over a steam space in the pressurizer 110 through the spray nozzle 150 that is provided in a plural number. In the process, high-temperature stream loses heat to be condensed and condensed water is collected in a lower portion of the pressurizer 110. The condensed water returns to a hot leg pipe of the reactor coolant system, and spray water of a necessary amount continuously circulates from cold leg pipes. As the high-temperature steam is condensed so that condensed water is formed and the overall temperature is lowered, the pressure in the pressurizer 110 decreases

The pressurizer spray apparatus 100 with half-circle type nozzles according to the above-described embodiment has the following effects.

First, the spray nozzle 150 is provided in a plural number so that a spray effect may be improved due to wider spraying.

Also, as the shape of the spray nozzle 150 is half circular and the spray ring 130 is horizontally arranged in the pressurizer 110, the spray ring 130 may maintain a state of being filled with the low-temperature coolant. (If the spray ring 130 is not horizontally arranged, the coolant may flow into the spray nozzle 150)

Accordingly, the pipe where thermal stratification is formed may be removed and thus the effect of loads due to a temperature difference generated by the thermal stratification may be reduced and piping fatigue may be reduced as well. Also, piping design may be facilitated as the effect of thermal loads is reduced. (As the effect of thermal loads due to the thermal stratification is reduced, variables to be considered for design decrease so that the design may be facilitated.)

In addition, as the connecting pipe 140 includes the first bent portion 141 and the second bent portion 142 and has a “duck's neck” shape (“S” shape), mechanical loads of the respective elements due to thermal expansion may be absorbed.

According to the above-described effects of the pressurizer spray apparatus 100 with half-circle type nozzles, operating conditions that are more advantageous for securing integrity of the reactor coolant pressure boundary may be satisfied.

As described above, the pressurizer spray apparatus with half-circle type nozzles according to the above embodiment may reduce influence due to a change in the temperature of piping and thermal stratification and decrease piping fatigue by using a spray ring having half-circle type nozzles, thereby removing piping region in which two types of fluids having a large temperature difference coexist.

Furthermore, as a plurality of spray nozzles are used, spray sources are diversified and thus a spray effect may be improved. Also, a rapid spray effect is obtained and thus integrity challenge of the reactor coolant pressure boundary may not be lowered.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A pressurizer spray apparatus with half-circle type nozzles, which is provided in a pressurizer of a pressurized light-water reactor type nuclear power plant, the pressurizer spray apparatus comprising:
a spray inlet pipe penetrating the pressurizer from outside to inside and having a hollow tube shape;
a spray ring arranged inside the pressurizer and having a ring shape and a hollow tube shape;
a connecting pipe connecting the spray ring and the spray inlet pipe and having a hollow tube shape; and
a spray nozzle provided on an outer circumferential surface of the spray ring and capable of discharging a low-temperature coolant into the pressurizer.

2. The pressurizer spray apparatus of claim 1, wherein the spray ring is horizontally arranged in the pressurizer.

3. The pressurizer spray apparatus of claim 1, wherein inside of the spray inlet pipe and the spray ring are filled with the low-temperature coolant.

4. The pressurizer spray apparatus of claim 1, wherein the spray nozzle is provided in a plural number on the outer circumferential surface of the spray ring, and the spray nozzle has a half-circular shape.

5. The pressurizer spray apparatus of claim 1, wherein the connecting pipe comprises a first bent portion connected to the spray inlet pipe in a “U” shape lying horizontally and a second bent portion connected to the first bent portion in a “U” shape lying horizontally, and
one end of the second bent portion is connected to the spray ring.

6. The pressurizer spray apparatus of claim 1, wherein the spray inlet pipe is provided in a plural number and connected to the spray ring via the connecting pipe, the connecting pipe being provided in a plural number and the plurality of spray inlet pipes are communicated with one another through the spray ring.
